(19) United States
(12) Patent Application Publication
(10) Pub. No.: US 2022/0402697 A1
(43) Pub. Date: Dec. 22, 2022

(54) SLIDING TRAY SYSTEM

(71) Applicant: LSC Development, LLC, Barrington, IL (US)

(72) Inventors: Jean Jodoin, Barrington, IL (US); Christopher Barry, Barrington, IL (US)

(21) Appl. No.: 17/841,897

(22) Filed: Jun. 16, 2022

Related U.S. Application Data
(60) Provisional application No. 63/212,445, filed on Jun. 18, 2021.

(51) Int. Cl. B65G 1/10; A47B 88/437; A47B 88/407

(52) U.S. Cl. CPC B65G 1/10; A47B 88/437; A47B 88/407

(57) ABSTRACT

A sliding tray system for a storage unit to allow a user to easily access and utilize the rear of an elevated storage unit. The sliding tray system has a tray, roller supports, rollers, two tracks, and a pull strap. The tray has a well having a bottom wall, side walls and flanges extending outwardly from the side walls at a top of the well. The rollers are secured to the roller support and ride within the tracks. Additionally, retaining walls are secured to the flanges to provide a rear wall for the sliding tray system. Preferably, the retaining walls do not extend from the second end of the tray all the way to the first end of the tray.

### CROSS-REFERENCE TO RELATED APPLICATIONS

This application claims the benefit of U.S. Provisional Patent Application No. 63/212,445 filed Jun. 18, 2021, which is expressly incorporated herein by reference and made a part hereof.

### FEDERALLY SPONSORED RESEARCH OR DEVELOPMENT

Not Applicable.

### TECHNICAL FIELD

The present subject matter relates to sliding tray system, and more particularly, to a sliding tray system for a storage locker.

### BACKGROUND

Sliding trays are known in the art. While such products according to the prior art provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to a sliding tray system, such as for a storage locker.

The disclosed technology further relates to a sliding tray system for a storage unit, comprising: a tray having a first end, a second end, a first side, and a second side, the tray further having a well having a bottom wall, side walls and flanges extending outwardly from the side walls at a top of the well; a plurality of retaining walls secured to the flanges of the tray; roller supports connected to the tray, wherein the roller supports comprise first and second roller supports adjacent the first end of the tray, and third and fourth roller supports adjacent the second end of the tray; a plurality of rollers, wherein one of the plurality of rollers is secured to each of the first, second, third and fourth roller supports, respectively; a first track adjacent the first side of the tray, and a second track adjacent the second side of the tray, wherein the first and second tracks receive the rollers, wherein the first and second tracks comprise a generally U-shaped member with a bottom wall, side wall and top wall to retain the rollers, and wherein the rollers can traverse in the first and second tracks, respectively; and, a pull strap adjacent the first end of the tray.

The disclosed technology further relates to a sliding tray system for a storage unit, comprising: a tray having a first end, a second end, a first side, and a second side, the tray further having a well having a bottom wall, side walls and flanges extending outwardly from the side walls at a top of the well; roller supports connected to the tray; a plurality of rollers, wherein one of the plurality of rollers is secured to each of the first, second, third and fourth roller supports, respectively; a first track adjacent the first side of the tray, and a second track adjacent the second side of the tray, wherein the first and second tracks receive the rollers, wherein the first and second tracks comprise a generally U-shaped member with a bottom wall, side wall and top wall to retain the rollers, wherein the first and second tracks have an opening in the top wall to allow for insertion of the rollers of the sliding tray system. and wherein the rollers can traverse in the first and second tracks, respectively; and, a pull strap adjacent the first end of the tray.

The disclosed technology further relates to a sliding tray system for a storage unit, comprising: a tray having a first end, a second end, a first side, and a second side, and flanges extending outwardly from a perimeter of the tray; a plurality of retaining walls secured to the flanges of the tray adjacent the first side, second side and second end of the tray, wherein the retaining walls adjacent the first and second sides of the tray do not extend from the second end of the tray all the way to the first end of the tray; roller supports connected to the tray, wherein the roller supports comprise first and second roller supports adjacent the first end of the tray, and third and fourth roller supports adjacent the second end of the tray; a plurality of rollers, wherein one of the plurality of rollers is secured to each of the first, second, third and fourth roller supports, respectively; a first track adjacent the first side of the tray, and a second track adjacent the second side of the tray, wherein the first and second tracks receive and retain the rollers such that the rollers can traverse linearly in the first and second tracks, respectively; and, a pull strap adjacent the first end of the tray.

The disclosed technology further relates to a sliding tray system, wherein the retaining walls comprise first, second and third retaining walls, and further including auxiliary supports for the first, second and third retaining walls.

The disclosed technology further relates to a sliding tray system, wherein the retaining walls are secured to the flanges of the tray.

The disclosed technology further relates to a sliding tray system, wherein the retaining walls adjacent the first and second sides of the tray do not extend from the second end of the tray all the way to the first end of the tray.

The disclosed technology further relates to a sliding tray system, wherein the auxiliary supports are provided adjacent a top of the retaining walls.

The disclosed technology further relates to a sliding tray system, wherein the roller supports comprise first and second roller supports adjacent the first end of the tray, and third and fourth roller supports adjacent the second end of the tray.

The disclosed technology further relates to a sliding tray system, wherein the rollers comprise a wheel and shaft, the shaft extending into the roller supports.

The disclosed technology further relates to a sliding tray system, wherein the rollers are adjustably positioned within the roller supports to adjust the distance of the rollers from the side walls of the well of the tray.

The disclosed technology further relates to a sliding tray system, wherein the roller supports are connected to the tray adjacent the side walls of the well.

The disclosed technology further relates to a sliding tray system, wherein the tracks have an opening in the top wall to allow for insertion of the rollers of the sliding tray system.

The disclosed technology further relates to a sliding tray system, wherein the first and second tracks comprise a generally U-shaped member with a bottom wall, side wall and top wall to retain the rollers, and wherein the first and second tracks have an opening in the top wall to allow for insertion of the rollers of the sliding tray system.

The disclosed technology further relates to a sliding tray system, wherein the flanges at the first side and the second side of the tray extend outwardly to cover the rollers and tracks.

The disclosed technology further relates to a sliding tray system, further comprising a push bar to assist a user in pushing the tray back in the storage unit.

The disclosed technology further relates to a sliding tray system, further comprising an auxiliary roller positioned about a centerline of the tray and secured to the bottom wall of the tray, the auxiliary roller being located between the first end and the second end of the tray.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1A is a front perspective view of a sliding tray system according to the present disclosure, shown in its environment of use.

FIG. 1B is a perspective view of a push bar and clamp holder for use with the sliding tray system according to the present disclosure.

FIG. 2 is a exploded front perspective view of one embodiment of the sliding tray system of FIG. 1.

FIG. 3 is front perspective view of a portion of the sliding tray system of FIG. 1 during a step of assembly.

FIG. 4 is front perspective view of a portion of the sliding tray system of FIG. 1 during another step of assembly.

FIG. 5 is a front perspective view of the sliding tray system of FIG. 1 and a locking member for use in assembly thereof.

FIG. 6 is a front perspective view of the sliding tray system of FIG. 1 and the inserted locking member in assembly of the sliding tray system.

FIG. 7 is front perspective view of one embodiment of the assembled sliding tray system of FIG. 1 in a first position.

FIG. 8 is front perspective view of one embodiment of the assembled sliding tray system of FIG. 1 in a second position.

FIG. 9 is a side elevation view of the sliding tray system according to the present disclosure in the first position.

FIG. 10 is a side elevation view of the sliding tray system according to the present disclosure in the second position.

FIG. 11 is a partially exploded view of another embodiment of the sliding tray system, according to the present disclosure.

FIG. 12 is a side elevation view of the sliding tray system of FIG. 11 in the first position.

FIG. 13 is a side elevation view of the sliding tray system of FIG. 11 in the second position.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

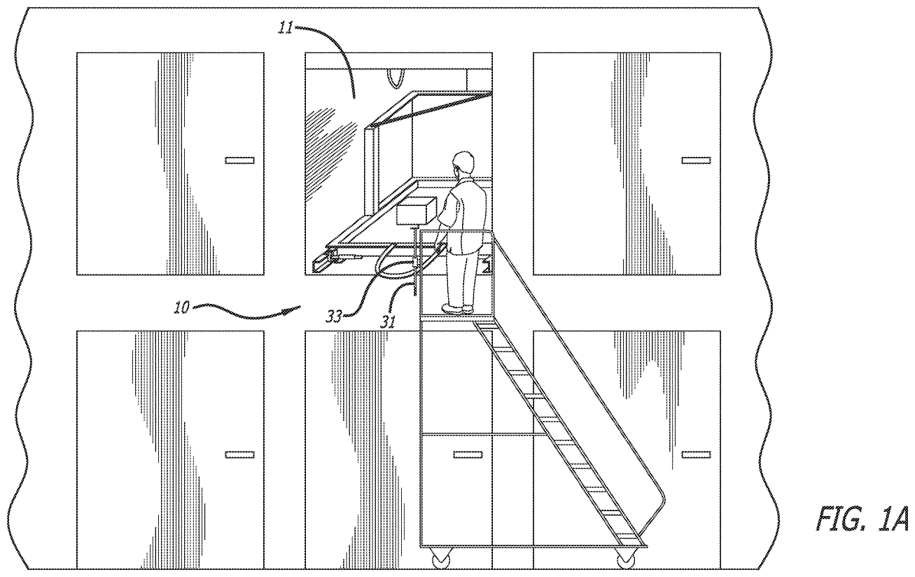

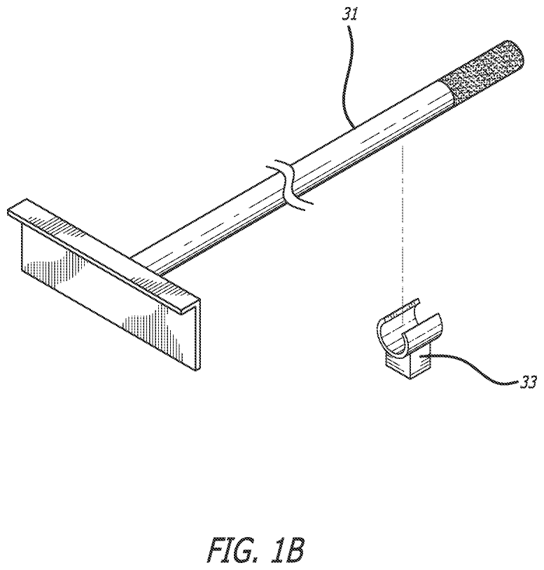

Generally, this disclosure describes several embodiments of sliding tray systems 10 that are arrangeable in a variety of different orientations, both alone and in combination. Typically, as shown in FIG. 1A, the sliding tray system 10 is utilized in storage units 11 where the rear of the storage unit 11 is not easily accessible, for example, in elevated storage units 11. As shown in FIG. 1A, users often have to climb ladders to access elevated storage units 11. Such storage areas may have a variety of sizes, such as being approximately five feet wide and approximately seven feet deep, or alternatively over eight feet wide and approximately seven feet deep. Of course alternate size storage areas may be provided, some of which are even deeper in size. When the user is on the ladder it is difficult to access the rear of the elevated storage unit 11 without getting off the ladder and physically entering the storage unit 11. However, the process of getting off the ladder and entering the storage unit 11, and then attempting to get back on the ladder from the elevated storage unit 11 may be difficult and physically challenging to some users. Accordingly, there is a need for a device to allow the user to access the rear of the elevated storage unit 11 without having to physically enter the elevated storage unit 11.

Referring now to the figures, and initially to FIGS. 1A-9, there is shown an embodiment of a sliding tray system 10 with various accessories that allows a user to safely and easily access the rear of an elevated storage unit 11. The sliding tray system 10 generally comprises a tray 12, first, second and third retaining walls 14, 16, 18, supports 20 for the retaining walls, a plurality of rollers 22, roller supports 24, first and second tracks 26, 28, and a pull strap 30. Additionally, the sliding tray system 10 may include a push bar 31 to assist the user in pushing the tray 12 back in the storage unit 11. The push bar 31 may be removably connected to the ladder with the use of a clamp holder 33 as shown in FIGS. 1A and 1B.

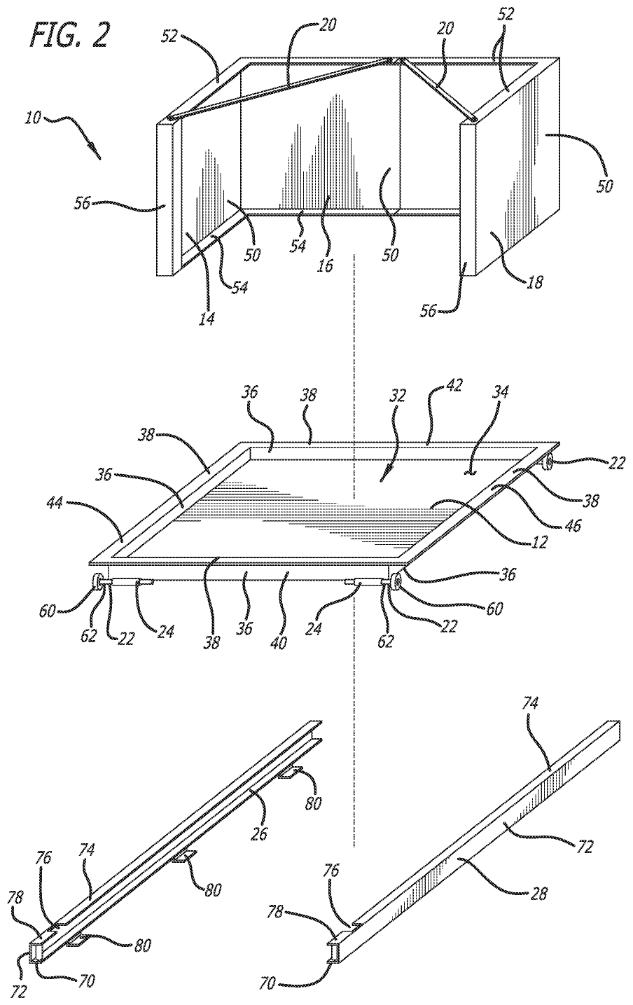

In one embodiment the tray 12 comprises a well 32 having a bottom wall 34, side walls 36 and flanges 38 extending from the side walls 36 at a top of the well 32. In one embodiment the depth of the well 32, which is approximately the same as the height of the side walls 36, is approximately between one and a half to two inches, however, that dimension may be larger or smaller with different embodiments of the tray 12. The tray 12 has a first end 40 and a second end 42, and a first side 44 and a second side 46. In one embodiment there are side walls 36 adjacent each of the first end 40, second end 42, first side 44 and second side 46 of the tray 12. Preferably, the pull strap 30 is provided adjacent the first end 40 of the tray 12, and the retaining walls 14, 16, 18 are preferably provided adjacent the second end 42 of the tray 12. All or some of the flanges 38 may extend outwardly from the side walls 36 as shown in FIG. 2, or alternately, while not shown in the figures, some of the flanges 38 may extend inwardly from the side walls 36, such as the flanges 38 at the first and second ends 40, 42 of the tray 12. Preferably, the flanges 38 at the first side 44 and second side 46 of the tray 12 extend outwardly to cover the rollers 22 and tracks 26, 28 for safety purposes. Accordingly, in one embodiment the flanges 38 are approximately two inches wide, however, not all of the flanges 38 need to be the same width. In a preferred embodiment, the length or depth of the tray 12 is approximately 41 inches long. Accordingly, when used in a seven foot deep storage unit 11 this embodiment of the tray 12 may take up approximately half of the overall depth of the storage unit 11.

In one embodiment, the tray 12 is made of 16 gauge galvanized steel, however, alternate materials and material thickness may be utilized. Additionally, in one embodiment the tray 12 is made of multiple components that are welded together. In alternate embodiments, however, certain components of the tray 12 may be made of the same sheet stock that is bent to form the tray 12. Alternately, components of the tray 12 may be made of aluminum, plastic or some other rigid material.

In one embodiment the sliding tray system 10 has a plurality of retaining walls. In one embodiment the retaining walls are secured to the flanges 38 of the tray 12 adjacent the first side, second side and second end of the tray 12. As best shown in FIGS. 2, 7 and 8, in one embodiment the retaining walls 14, 16 and 18 are positioned adjacent the second end 42 of the tray 12. The retaining walls 14, 16 and 18 preferably assist in preventing any boxes or other materials that the user may put on the tray 12 from falling backwards behind the tray 12. The retaining walls 14, 16 and 18 may comprise a wall member 50, a top flange 52 and a bottom flange 54. Additionally, in one embodiment the first and third retaining walls 14 and 18 have a side flange 56. If necessary, in a preferred embodiment, the retaining walls 14, 16 and 18 are fixedly connected together, such as by welding, however, in alternate embodiments the retaining walls 14, 16 and 18 are separate components. In a preferred embodiment the retaining walls 14, 16 and 18 are secured to the flanges 38 of the tray 12, such as with fasteners. Further, in one embodiment supports 20, such as auxiliary supports 20, are used to assist in providing rigidity to the top of the overall retaining wall structure. For example, as shown in FIG. 2, in one embodiment an auxiliary support 20 may join the top of the first retaining wall 14 with the top of the second retaining wall 16 at an area toward the center of the second retaining wall 16, and similarly in one embodiment another auxiliary support 20 may join the top of the third retaining wall 18 with the top of the second retaining wall 16 at an area toward the center of the second retaining wall 16. Further, in one embodiment the second retaining wall 16 may be made of two components that are secured together at a joint 58 to create a single retaining wall 16.

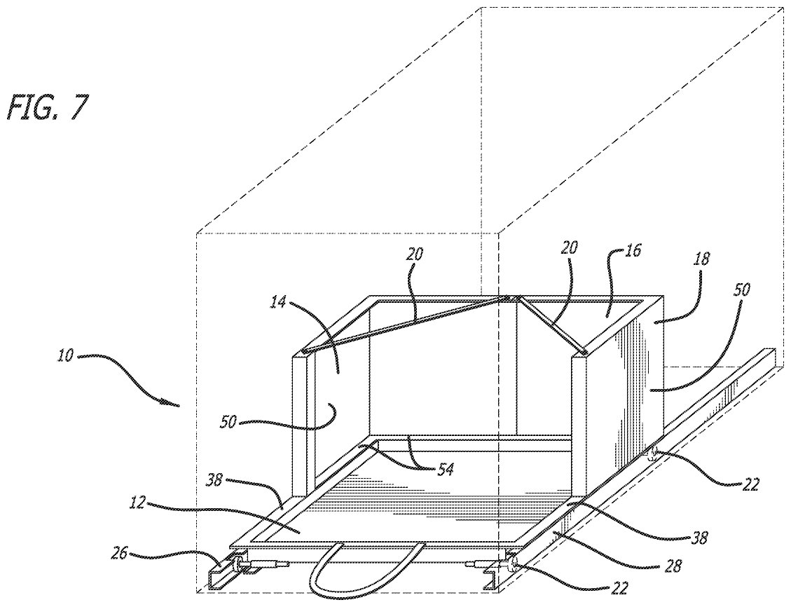

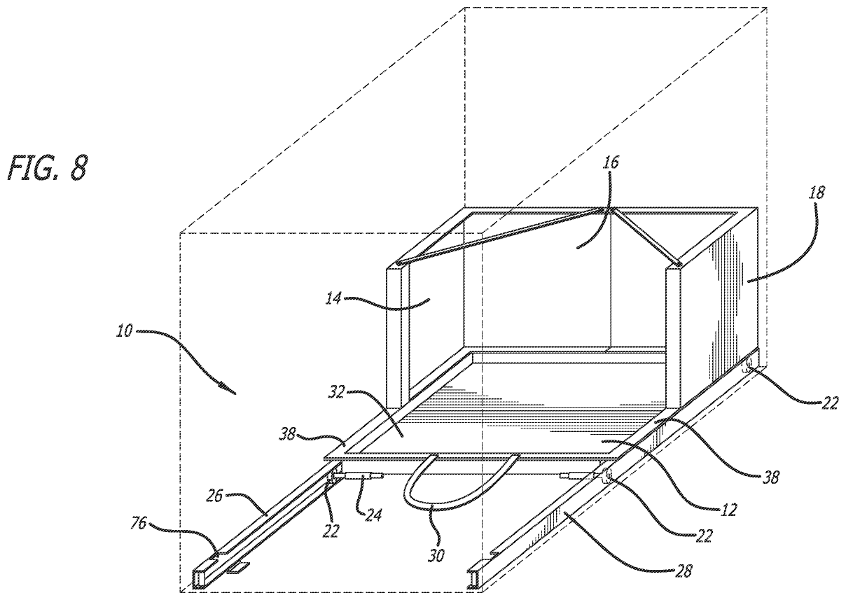

Referring to FIGS. 7 and 8, in one embodiment the retaining walls 14, 16 and 18 may not extend the entire length of the depth of the tray 12, and thus in one embodiment the retaining walls adjacent the first and second sides of the tray do not extend from the second end of the tray all the way to the first end of the tray. In one embodiment, the length or depth of the tray 12 is approximately 41 inches long, and the length of the first and third retaining walls 14 and 18 is approximately 24 inches. Further, in one embodiment the height of the retaining walls 14, 16 and 18 is approximately 36 inches high. This height of the retaining walls 14, 16 and 18 is typically less than the overall height of the storage unit 11, however the height of the retaining walls 14, 16 and 18 may be shorter or higher depending on the application.

In one embodiment, the retaining walls 14, 16 and 18 are made of 22 gauge galvanized steel, however, alternate materials and material thickness may be utilized. Additionally, in one embodiment the retaining walls 14, 16 and 18 are made of multiple components that are welded together. In alternate embodiments, however, certain components of the retaining walls 14, 16 and 18 may be made of the same sheet stock that is bent to form the retaining walls 14, 16 and 18. Alternately, components of the retaining walls 14, 16 and 18 may be made of aluminum, plastic or some other rigid material. And, in alternate embodiments supports may not be needed.

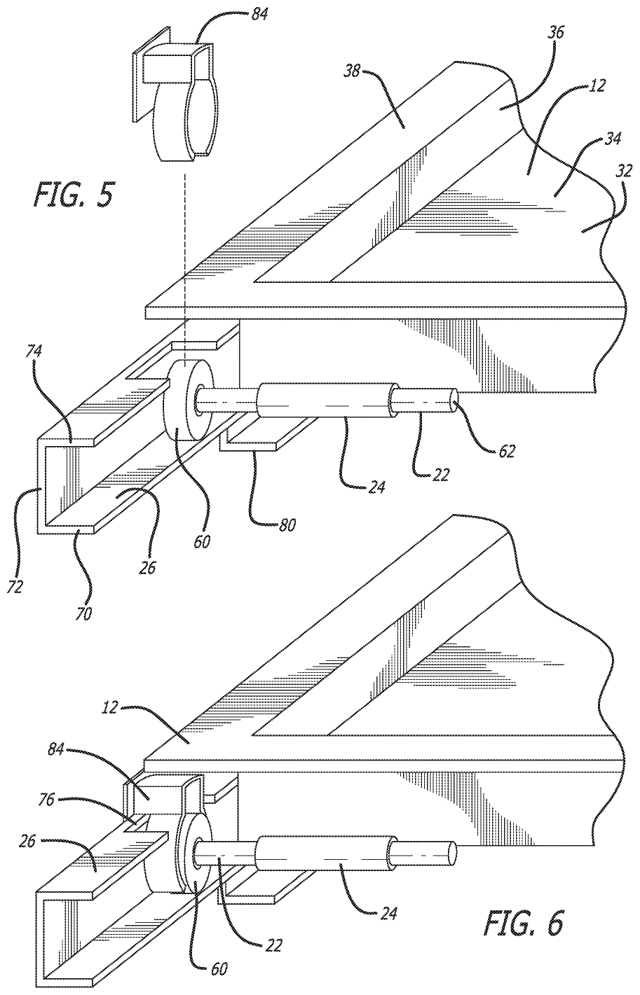

The sliding tray system 10 typically has a plurality of rollers 22 as shown in FIGS. 2 through 8 and 11. The rollers 22 are preferably connected to the tray 12, and in various embodiments are connected either to an exterior wall of the bottom wall 34 of the well 32 of the tray 12 or to the exterior wall of the side walls 36 of the tray 12. In one embodiment, roller supports 24 are connected or fixed to the tray 12, such as the exterior of the tray 12, and the roller supports 24 secure the rollers 22 to the tray 12. In one embodiment, the roller supports 24 comprise first and second roller supports 24 adjacent the first end 40 of the tray 12, and third and fourth roller supports 24 adjacent the second end 42 of the tray 12. In one embodiment, one of the plurality of rollers 22 is secured to each of the first, second, third and fourth roller supports 24, respectively. Preferably, the roller supports 24 allow the rollers 22 to be adjustable therein to properly align the tray 12 with respect to the tracks 26, 28. In one embodiment, the rollers 22 comprise a wheel 60 and a shaft 62. The wheels 60 are rotatable with respect to the shaft 62. And, in one embodiment the shaft 62 extends into the roller support 24 and is secured to the roller support 24 and linearly moveable to be adjustably positioned within the roller supports 24 for adjustment purposes to adjust the distance of the rollers from the side walls of the well of the tray 12. As shown in FIGS. 5 and 6, the wheels 60 of the rollers 22 are generally provided under the side flanges 38 of the tray 12.

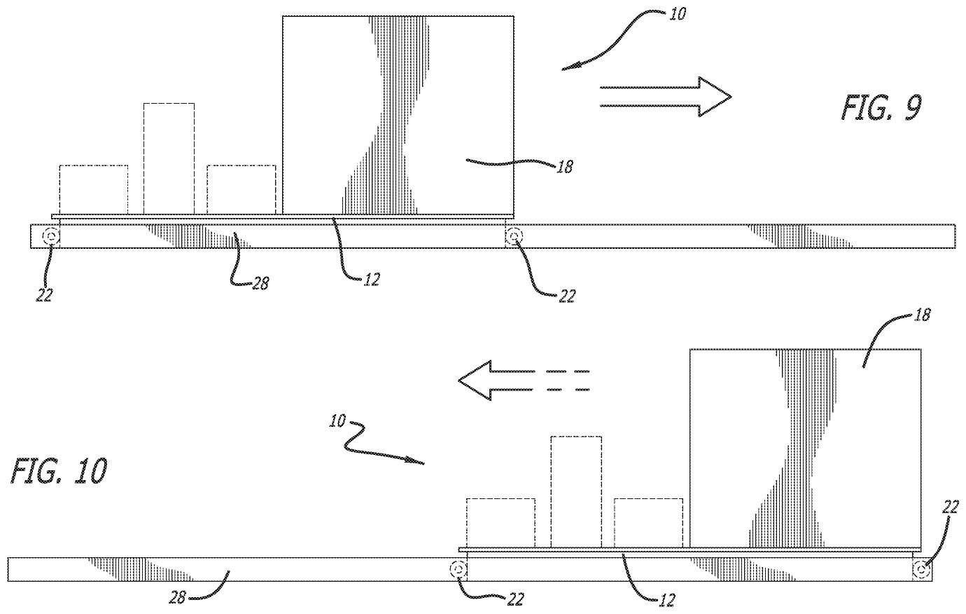

As shown in FIGS. 2-4 and 7-8, to provide for the sliding tray system 10 to traverse from the front of the storage unit 11 to the rear of the storage unit 11, the sliding tray system 10 includes opposing first and second tracks 26, 28. In one embodiment the first track 26 is adjacent the first side 44 of the tray, and the second track 28 is adjacent the second side 46 of the tray. In one embodiment, the tracks 26, 28 generally comprise a U-shaped member with a bottom wall 70, side wall 72 and top wall 74 to receive and retain the wheel 60 of the rollers 22. The rollers 22 can traverse linearly in the first and second tracks. The tracks 26, 28 generally extend from the front of the storage unit 11 to the rear of the storage unit 11 to allow a user to move the sliding tray 12 from the front of the storage unit 11, as show in FIGS. 7 and 9, to the rear of the storage unit 11, as shown in FIGS. 8 and 10, and then back as desired.

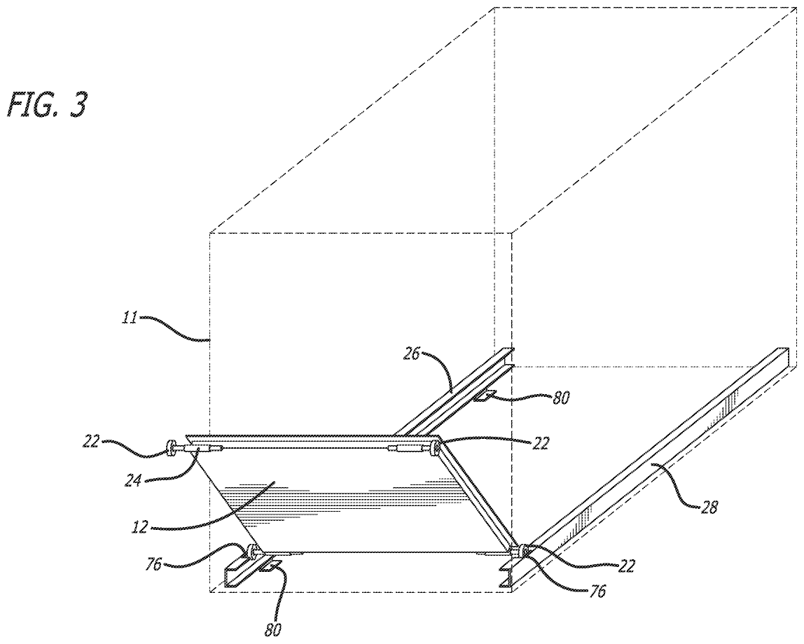

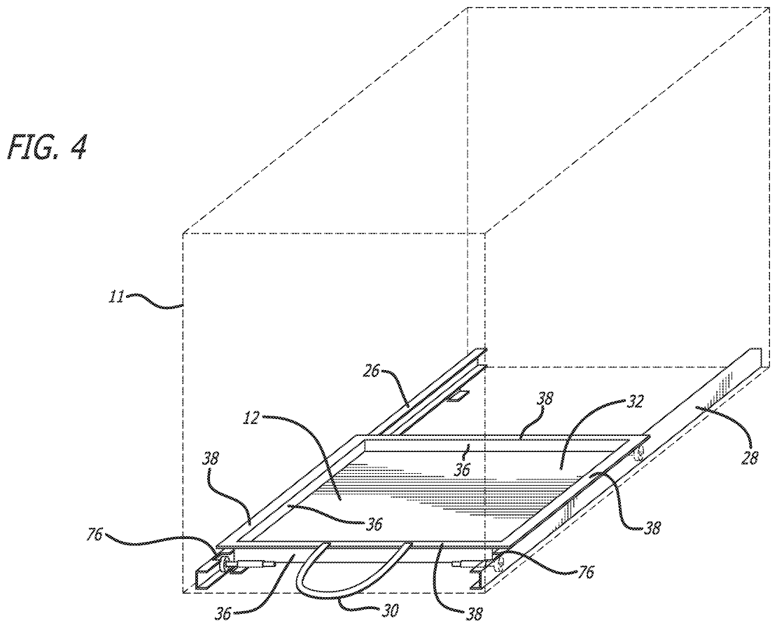

In one embodiment, the tracks 26, 28 have an opening 76 in the top wall 74 of the tracks 26, 28 toward a front 78 of the tracks 26, 28 to allow for insertion of the front and rear rollers 22, respectively, of the sliding tray system 10. The tracks 26, 28 also have feet 80. In one embodiment the feet 80 comprise an angle bracket. The feet 80 are secured to the tracks 26, 28 and then also secured to the floor of the storage unit 11 to secure the tracks 26, 28 therein, and, in a preferred embodiment, to raise the tracks 26, 28 a distance off the floor of the storage unit 11. Referring to FIG. 3, to position the tray 12 with the attached rollers 22 in the tracks 26, 28, the rear rollers 22 are first inserted through the opening 76 in the top wall 74 of the tracks 26, 28. The tray 12 is then moved toward the rear of the tracks 26, 28 until the front rollers 22 can be inserted into the opening 76 in the top wall 74 of the tracks 26, 28 as shown in FIG. 4.

To connect the retaining walls 14, 16 and 18 to the tray 12, it is preferred to use a stopper 84 as shown in FIGS. 5 and 6. The stopper 84 is secured to the front roller(s) 22 of the tray 12 and prevent the tray 12 from moving back and forth in the tracks 26, 28 to allow the retaining walls 14, 16 and 18 to be more easily secured to the tray 12 as explained herein. After the retaining walls 14, 16 and 18 are secured to the tray 12 the stopper 84 can be removed. In an alternate embodiment, the opening 76 in the top wall 74 of the tracks 26, 28 may be covered with a plate (not shown).

After the tray 12 is properly inserted in the tracks 26, 28 and the retaining walls 14, 16 and 18 are secured to the tray 12, the tray 12 may be loaded by a user in the front of the storage unit 11 and then slid back to the rear of the storage unit 11, as shown in FIGS. 9 and 10, so that additional items can be located in the front of the storage unit 11, but not on the tray 12. Then, when one wants to access the items on the tray 12 the user can slide the tray 12 back to the front of the storage unit 11 as shown in FIG. 10.

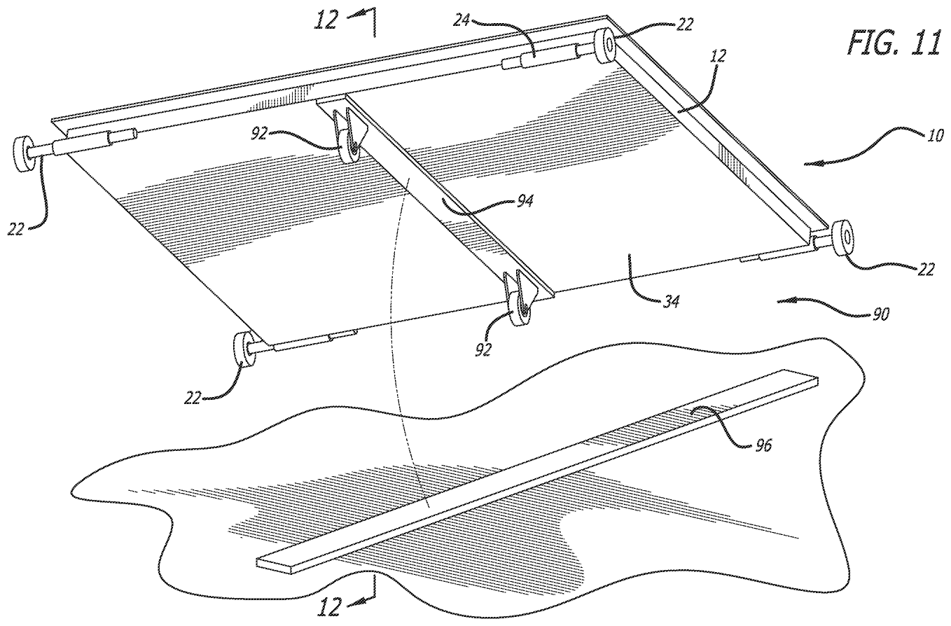

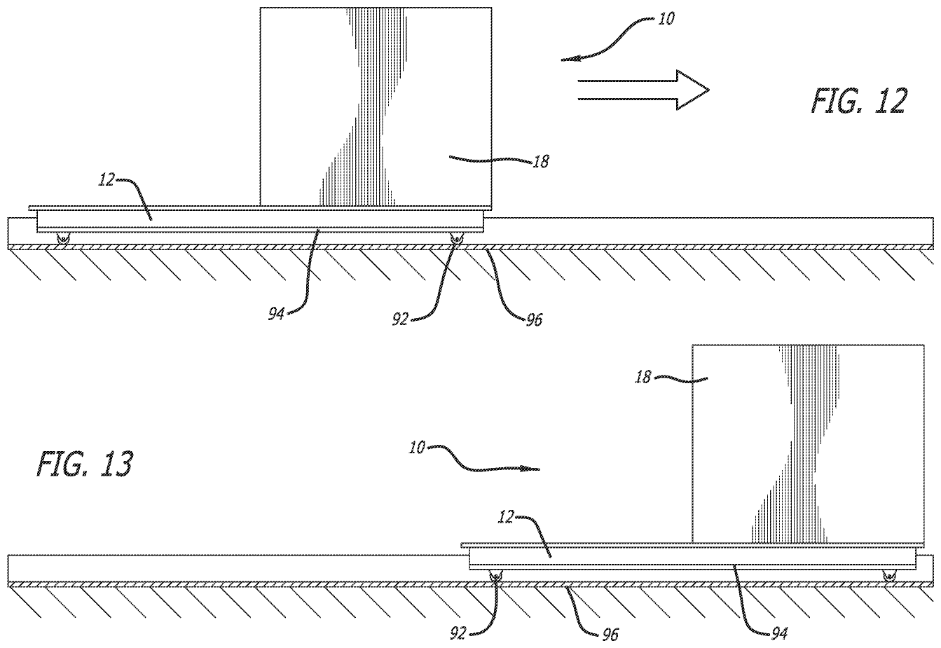

In various embodiments, including when the width of the tray 12 is large, a supplemental roller system 90 may be employed to provide additional support for the tray 12. For example, as shown in FIGS. 11-13, in one embodiment, auxiliary rollers 92 may be secured to the bottom wall 34 of the tray 12. In one embodiment two auxiliary rollers 92 positioned toward the first and second ends 40, 42, respectively, of the tray 12 are utilized. In an alternate embodiment, however, only one auxiliary roller 92 is employed toward a middle of the tray 12. In on embodiment, the auxiliary rollers 92 are positioned about a centerline of the tray 12. The auxiliary rollers 92 may be secured directly to the tray 12, or a supplement support 94 may be secured to the tray 12 to provide additional rigidity to the tray 12 and the auxiliary rollers 92 may be secured to the supplemental support 94. Additionally, in another embodiment a flat track 96 may be secured to the floor of the storage unit 11, as shown in FIG. 11, to provide a support surface for the rollers 94. However, in alternate embodiments one or both of the supplemental support 94 and/or the flat track 96 may not be needed.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A sliding tray system for a storage unit, comprising:
a tray having a first end, a second end, a first side, and a second side, the tray further having a well having a bottom wall, side walls and flanges extending outwardly from the side walls at a top of the well;
a plurality of retaining walls secured to the flanges of the tray;
roller supports connected to the tray, wherein the roller supports comprise first and second roller supports adjacent the first end of the tray, and third and fourth roller supports adjacent the second end of the tray;
a plurality of rollers, wherein one of the plurality of rollers is secured to each of the first, second, third and fourth roller supports, respectively;
a first track adjacent the first side of the tray, and a second track adjacent the second side of the tray, wherein the first and second tracks receive the rollers, wherein the first and second tracks comprise a generally U-shaped member with a bottom wall, side wall and top wall to retain the rollers, and wherein the rollers can traverse in the first and second tracks, respectively; and,
a pull strap adjacent the first end of the tray.

2. The sliding tray system of claim 1, wherein the retaining walls comprise first, second and third retaining walls, and further including auxiliary supports for the first, second and third retaining walls.

3. The sliding tray system of claim 2, wherein the auxiliary supports are provided adjacent a top of the retaining walls.

4. The sliding tray system of claim 1, wherein the retaining walls adjacent the first and second sides of the tray do not extend from the second end of the tray all the way to the first end of the tray.

5. The sliding tray system of claim 1, wherein the rollers comprise a wheel and shaft, the shaft extending into the roller supports.

6. The sliding tray system of claim 1, wherein the rollers are adjustably positioned within the roller supports to adjust the distance of the rollers from the side walls of the well of the tray.

7. The sliding tray system of claim 1, wherein the roller supports are connected to the tray adjacent the side walls of the well.

8. The sliding tray system of claim 1, wherein the flanges at the first side and the second side of the tray extend outwardly to cover the rollers and tracks.

9. The sliding tray system of claim 1, further comprising a push bar to assist a user in pushing the tray back in the storage unit.

10. The sliding tray system of claim 1, wherein the tracks have an opening in the top wall to allow for insertion of the rollers of the sliding tray system.

11. The sliding tray system of claim 1, further comprising an auxiliary roller positioned about a centerline of the tray and secured to the bottom wall of the tray, the auxiliary roller being located between the first end and the second end of the tray.

12. A sliding tray system for a storage unit, comprising:
a tray having a first end, a second end, a first side, and a second side, the tray further having a well having a bottom wall, side walls and flanges extending outwardly from the side walls at a top of the well;
roller supports connected to the tray;
a plurality of rollers, wherein one of the plurality of rollers is secured to each of the first, second, third and fourth roller supports, respectively;
a first track adjacent the first side of the tray, and a second track adjacent the second side of the tray, wherein the first and second tracks receive the rollers, wherein the first and second tracks comprise a generally U-shaped member with a bottom wall, side wall and top wall to retain the rollers, wherein the first and second tracks have an opening in the top wall to allow for insertion of the rollers of the sliding tray system. and wherein the rollers can traverse in the first and second tracks, respectively; and,
a pull strap adjacent the first end of the tray.

13. The sliding tray system of claim 12, wherein the roller supports comprise first and second roller supports adjacent the first end of the tray, and third and fourth roller supports adjacent the second end of the tray.

14. The sliding tray system of claim 12, further comprising a plurality of retaining walls secured to the flanges of the tray.

15. The sliding tray system of claim 14, wherein the retaining walls comprise first, second and third retaining walls, and wherein the retaining walls adjacent the first and second sides of the tray do not extend from the second end of the tray all the way to the first end of the tray.

16. The sliding tray system of claim 15, further comprising auxiliary supports adjacent a top of the retaining walls.

17. The sliding tray system of claim 12, further comprising an auxiliary roller positioned about a centerline of the tray and secured to the bottom wall of the tray, the auxiliary roller being located between the first end and the second end of the tray.

18. A sliding tray system for a storage unit, comprising:
a tray having a first end, a second end, a first side, and a second side, and flanges extending outwardly from a perimeter of the tray;
a plurality of retaining walls secured to the flanges of the tray adjacent the first side, second side and second end of the tray, wherein the retaining walls adjacent the first and second sides of the tray do not extend from the second end of the tray all the way to the first end of the tray;
roller supports connected to the tray, wherein the roller supports comprise first and second roller supports adjacent the first end of the tray, and third and fourth roller supports adjacent the second end of the tray;
a plurality of rollers, wherein one of the plurality of rollers is secured to each of the first, second, third and fourth roller supports, respectively;
a first track adjacent the first side of the tray, and a second track adjacent the second side of the tray, wherein the first and second tracks receive and retain the rollers such that the rollers can traverse linearly in the first and second tracks, respectively; and,
a pull strap adjacent the first end of the tray.

19. The sliding tray system of claim 18, wherein the first and second tracks comprise a generally U-shaped member with a bottom wall, side wall and top wall to retain the rollers, and wherein the first and second tracks have an opening in the top wall to allow for insertion of the rollers of the sliding tray system.

20. The sliding tray system of claim 18, further comprising an auxiliary roller positioned about a centerline of the tray and secured to the bottom wall of the tray, the auxiliary roller being located between the first end and the second end of the tray.
